(19) United States
(12) Patent Application Publication
(10) Pub. No.: US 2007/0238384 A1
(43) Pub. Date: Oct. 11, 2007

(54) Articles, operating room drapes and methods of making and using the same

(76) Inventors: Ming Tang, Macon, GA (US); Haisu Tang, Zhejang (CN)

Correspondence Address: WITHERS & KEYS, LLC, P. O. BOX 2049, MCDONOUGH, GA, 30253, US

(21) Appl. No.: 11/726,087

(22) Filed: Mar. 20, 2007

Related U.S. Application Data
(60) Provisional application No. 60/784,405, filed on Mar. 20, 2006.

(51) Int. Cl. B31B 1/60; B32B 5/26; B32B 27/12; D04H 1/00

(52) U.S. Cl. 442/381; 442/394; 442/382; 442/417; 442/396; 156/60

(57) ABSTRACT

Biodegradable and/or water-soluble articles and operating room drapes are disclosed. Methods of making and using biodegradable and/or water-soluble articles and operating room drapes are also disclosed.

### CROSS-REFERENCE TO RELATED APPLICATIONS

This patent application claims the benefit of priority to U.S. Provisional Patent Application Ser. No. 60/784,405 entitled “Articles, Operating Room Drapes and Methods of Making and Using the Same”, filed on Mar. 20, 2006, the subject matter of which is incorporated herein in its entirety

### FIELD OF THE INVENTION

The present invention relates generally to multi-layer biodegradable and/or water-soluble articles including, but not limited to, articles of clothing and operating room drapes; methods of making biodegradable and/or water-soluble articles and operating room drapes; and methods of using biodegradable and/or water-soluble articles and operating room drapes in an operating room setting.

### BACKGROUND OF THE INVENTION

A variety of drapes and linens are used in operating rooms. Drapes and linens may be used to protect and/or cover a patient, to protect and/or cover a piece of operating room equipment, or both. During surgical procedures, it is important for an equipment drape to provide a barrier between the patient and operating room equipment so as to protect the operating room equipment from exposure to body fluids and any other contaminants. Efforts continue in the design of equipment drapes to further enhance the properties of equipment drapes.

Further, due to the large number of medical facilities utilizing such articles, millions of pounds of waste are created each year. The waste ends up in landfills and has a dramatic impact on the environment. Much of the generated waste is related to the use of disposable materials, such as personal protective clothing and gowns, equipment drapes, and accessories necessary for patient care. These disposable materials become contaminated with bloodborne pathogens and are therefore unsafe for reuse. To prevent the spread of disease, these materials are typically discarded after a single use.

What is needed in the art is a biodegradable and/or water-soluble article suitable for use in an operating room environment, wherein the biodegradable and/or water-soluble article has one or more of the following properties: (i) provides superior barrier protection to a person or piece of equipment; (ii) provides a desired absorbency capacity; (iii) may be disposed of so as to minimize waste product; (iv) provides superior strength; (v) provides superior comfort; (vi) provides a fluid impermeable layer; (vii) is economical; (viii) provides desired breathability; and (ix) provides flame resistance.

### SUMMARY OF THE INVENTION

The present invention is directed to a biodegradable and/or water-soluble article suitable for use in an operating room setting. The biodegradable and/or water-soluble article of the present invention provides one or more of the following features: (i) superior barrier protection to a person or a piece of equipment, (ii) the ability to absorb one or more body fluids from a patient, (iii) the minimization of disposable waste and contaminants, (iv) superior strength, (v) superior comfort, (vi) a fluid impermeable layer, (vii) low cost of production, (viii) desired breathability, and (ix) flame resistance.

According to one exemplary embodiment of the present invention, the biodegradable and/or water-soluble article has a first layer of nonwoven fabric extending along a first surface of the article, the first layer of nonwoven fabric comprising hot water-soluble fibers, a second layer of nonwoven fabric extending along a second surface of the article, the second layer of nonwoven fabric comprising hot water-soluble fibers, and a polymeric film layer positioned between and bonded to the first and second layers of nonwoven fabric, the polymeric film layer comprising (i) a biodegradable polymer that is not water-soluble or (ii) a water-soluble polymer.

According to a further exemplary embodiment of the present invention, the biodegradable and/or water-soluble article is an operating room drape and comprises a first layer of nonwoven fabric extending along a first surface of the article, the first layer of nonwoven fabric comprising hot water-soluble polyvinyl alcohol fibers; a second layer of nonwoven fabric extending along a second surface of the article, the second layer of nonwoven fabric comprising hot water-soluble polyvinyl alcohol fibers; and a liquid impervious polymeric film layer positioned between and bonded to said first and second layers of nonwoven fabric without an additional bonding agent, said polymeric film layer comprising (i) a biodegradable polymer that is not water-soluble or (ii) a water-soluble polymer.

The present invention is also directed to an article of clothing comprising a first layer of nonwoven fabric extending along a first surface of the article, the first layer of nonwoven fabric comprising hot water-soluble polyvinyl alcohol fibers; a second layer of nonwoven fabric extending along a second surface of the article, the second layer of nonwoven fabric comprising hot water-soluble polyvinyl alcohol fibers; and a breathable unstretched polymeric film layer positioned between and bonded to the first and second layers of nonwoven fabric, the breathable unstretched polymeric film layer comprising (1) a polymer matrix comprising (i) a biodegradable polymer that is not water-soluble or (ii) a water-soluble polymer, and (2) filler particles distributed throughout the polymer matrix.

The present invention is further directed to methods of making a breathable unstretched water-soluble polyvinyl alcohol film. In one exemplary embodiment, the method of making a breathable unstretched water-soluble polyvinyl alcohol film comprises forming an aqueous mixture of (i) water-soluble polyvinyl alcohol, and (ii) inorganic nanoparticles (e.g., calcium carbonate nanoparticles); depositing the mixture onto a moving surface traveling through an oven; subjecting the deposited mixture to heat so as to remove water; and separating the resulting film from the moving surface without stretching the film.

The present invention is even further directed to methods of making an article using a high frequency bonding or welding technique. In one exemplary embodiment, the method of making an article comprises feeding (i) a first layer of nonwoven fabric comprising hot water-soluble polyvinyl alcohol fibers, (ii) a second layer of nonwoven fabric comprising hot water-soluble polyvinyl alcohol fibers, and (iii) a biodegradable or water-soluble polymeric film layer positioned between the first and second layers of nonwoven fabric into a high frequency welding apparatus, wherein the high frequency welding apparatus comprises a pair of nip rollers comprising (i) a first roller having a plurality of protrusions along an outer surface of the first roller, and (ii) a second roller having a substantially smooth surface, the high frequency welding apparatus providing high frequency energy across a nip area between the protrusions of the first roller and the substantially smooth surface of the second roller; and bonding the first layer of nonwoven fabric, the second layer of nonwoven fabric, and the polymeric film layer to one another via the high frequency energy.

The present invention is even further directed to methods of using an equipment drape in an operating room setting. In one exemplary embodiment of the present invention, the method comprises the steps of positioning an equipment drape over at least a portion of the piece of equipment to separate a patient from the portion of the piece of equipment, wherein the equipment drape comprises a first layer of nonwoven fabric extending along a first surface of the equipment drape, a second layer of nonwoven fabric extending along a second surface of the equipment drape, and a biodegradable or water-soluble polymeric film layer with a first biodegradable or water-soluble polymeric film surface bonded to at least a portion of the first layer of nonwoven fabric and a second biodegradable or water-soluble polymeric film surface bonded to at least a portion of the second layer of nonwoven fabric.

These and other features and advantages of the present invention will become apparent after a review of the following detailed description of the disclosed embodiments and the appended claims.

### BRIEF DESCRIPTION OF THE FIGURES

The present invention is further described with reference to the appended figures, wherein:

FIG. 1 depicts a cross-sectional view of an exemplary biodegradable and/or water-soluble article of the present invention; and

FIG. 2 depicts a view of the exemplary biodegradable and/or water-soluble article of FIG. 1 on an operating room table.

### DETAILED DESCRIPTION OF THE INVENTION

The present invention is directed to biodegradable and/or water-soluble articles suitable for use as operating room drapes (e.g., patient drapes and equipment drapes), patient gowns, and other articles typically used in an operating room setting. The present invention is further directed to methods of making and using biodegradable and/or water-soluble articles in an operating room setting, as well as methods of making components suitable for use in biodegradable and/or water-soluble articles such as a breathable water-soluble film. The articles of the present invention are particularly useful for covering a portion of a patient during an operating room procedure and/or providing a barrier between a patient and one or more pieces of equipment in an operating room setting. The articles of the present invention may comprise at least three distinct layers of material, each of which provides a desired property to the resulting article.

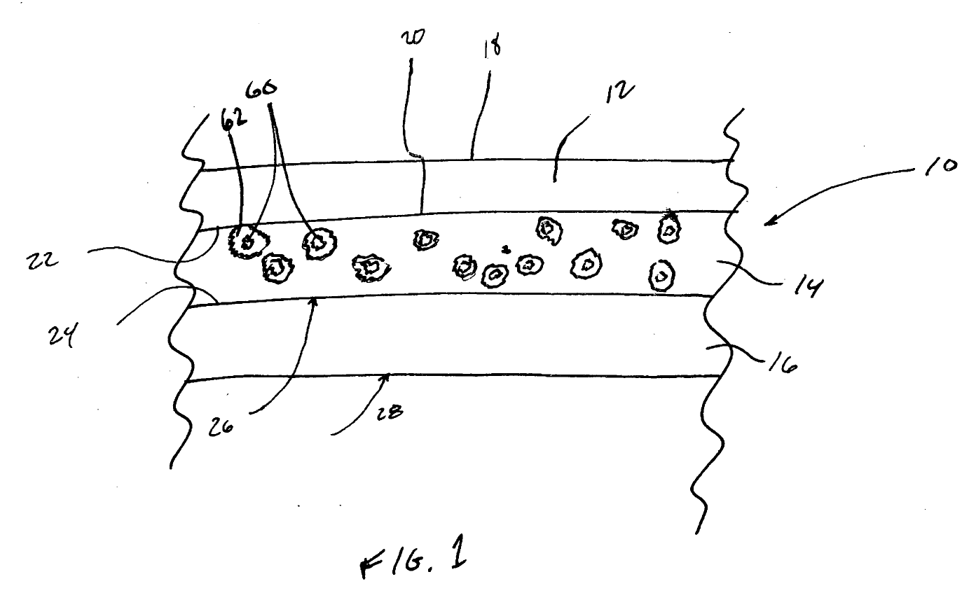

An exemplary biodegradable and/or water-soluble article 10 of the present invention is shown in FIG. 1. Exemplary biodegradable article 10 has a first layer of nonwoven fabric 12, a polymeric film layer 14, and a second layer of nonwoven fabric 16. As shown in FIG. 1, first layer of nonwoven fabric 12 forms a first surface 18 of article 10. In the exemplary embodiment shown, first layer of nonwoven fabric 12 also has a first interior surface 20, which is bonded to at least a portion of a corresponding surface 22 of polymeric film layer 14. In this exemplary embodiment, polymeric film layer 14 also has a second surface 24, which is bonded to at least a portion of a corresponding surface 26 of second layer of nonwoven fabric 16. Finally, second layer of nonwoven fabric 16 forms a second surface 28 of the article 10. First surface 18 and second surface 28 are each suitable for contacting a patient or piece of equipment, such as an operating room table or operating room table mattress such that article 10 is reversible.

Although exemplary biodegradable and/or water-soluble article 10 is shown as having a rectangular cross-sectional shape, it should be noted that exemplary biodegradable and/or water-soluble article 10 may have any desired cross-sectional configuration and shape. As described below, any one or more of first layer of nonwoven fabric 12, polymeric film layer 14, and second layer of nonwoven fabric 16 may comprise a number of individual layers.

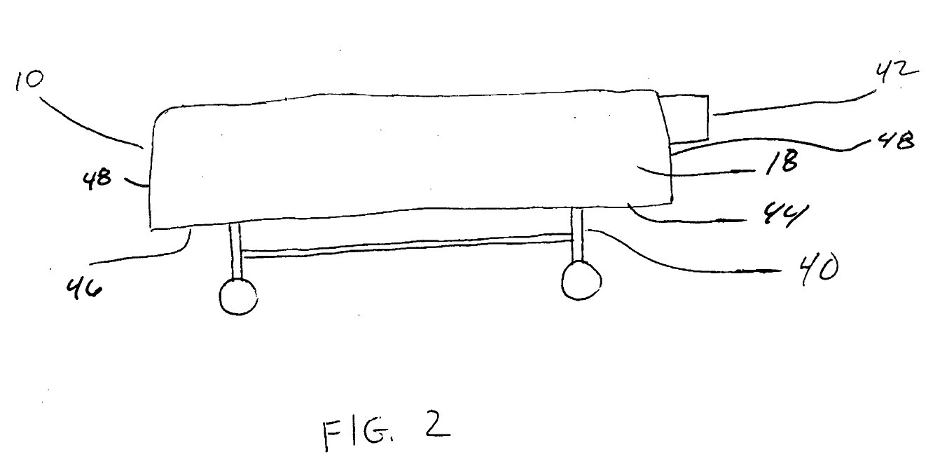

FIG. 2 depicts the use of exemplary biodegradable and/or water-soluble article 10 to cover at least a portion of a piece of equipment, in this particular case, exemplary operating room table 40 having operating room table mattress 42 thereon. As shown in FIG. 2, exemplary biodegradable and/or water-soluble article 10 can cover a portion of exemplary operating room table 40, or alternatively, can cover all of a piece of equipment, such as exemplary operating room table 40. Further, article 10 may have an outer periphery 44 extending along outer edges 46 and 48 of exemplary article 10. Though shown with a rectangular configuration in the figures, article 10 may have any shape including, but not limited to, rectangular, round, oblong, equipment-shaped, and as an article of clothing. A particularly useful shape is when article 10 is shaped as an article of clothing, particularly a medical gown to be worn by patients.

As described above, the biodegradable and/or water-soluble articles of the present invention may comprise a number of components. A description of some of the suitable exemplary components is provided below.

I. Biodegradable and/or Water-Soluble Articles

The biodegradable and/or water-soluble articles of the present invention may comprise, but are not limited to, one or more of the following components.

A. Article Components

The biodegradable and/or water-soluble articles of the present invention may comprise one or more of the following components.

1. First Layer of Nonwoven Fabric

The biodegradable and/or water-soluble articles of the present invention comprise a first layer of nonwoven fabric such as exemplary first layer on nonwoven fabric 12 of exemplary biodegradable and/or water-soluble article 10 shown in FIG. 1. In some embodiments, the first layer of nonwoven fabric layer is desirably a liquid pervious layer to enable fluids coming into contact with an upper/outer surface of the article to enter into the article and away from the upper/outer surface of the article (e.g., the first layer of nonwoven fabric has liquid wicking properties).

The first nonwoven fabric layer of the biodegradable and/or water-soluble article may comprise one or more layers of nonwoven fabric material positioned adjacent to and/or bonded to one another. In one exemplary embodiment, the first nonwoven fabric layer comprises a cross-lapped, spun-laced fabric.

Each of the first nonwoven fabric layers may be formed from a variety of materials. Suitable materials include, but are not limited to, polyvinyl alcohol fibers. Suitable PVA fibers and methods of making PVA fibers are disclosed in U.S. Pat. Nos. 5,181,967; 5,207,837; 5,268,222; 5,620,786; 5,885,907; and 5,891,812; the disclosures of all of which are incorporated herein by reference in their entirety. An example of a suitable water-soluble polyvinyl alcohol fiber for use in the present invention is a polyvinyl alcohol homopolymer that has been highly crystallized by post-drawing or by heat annealing. Any commercially available polyvinyl alcohol fiber is suitable for use in the present invention including, but not limited to, polyvinyl alcohol fibers commercially available from SINOPEC SINCHUAN VINYLON WORKS Company (Sichuan, China); Fujian Textile and Chemical Fiber Group Co. Ltd. (Fujian, China); and Hunan Xiangwei Co. Ltd. (Hunan, China).

Polyvinyl alcohol fibers are particularly preferred due to their absorbency characteristics and hot water solubility. It is preferred that the temperature of water solubility of first layer of nonwoven fabric 12 be considerably above body temperature so that it is absorbent for normal bodily fluids, but still water-soluble at elevated temperatures for environmental reasons. It is preferred that first layer of nonwoven fabric 12 is soluble in water having a water temperature of greater than about 37° C. It is more preferred that first layer of nonwoven fabric 12 is soluble in water having a water temperature of greater than about 50° C. It is even more preferred that first layer of nonwoven fabric 12 is soluble in water having a water temperature of greater than about 75° C. It is even more preferred that first layer of nonwoven fabric 12 is soluble in water having a water temperature of greater than about 90° C.

The fibers of the first nonwoven fabric layer desirably have an average fiber diameter of less than about 100 microns. More desirably, the fibers of the first nonwoven fabric layer have an average fiber diameter of from about 0.5 micron to about 40 microns. Even more desirably, the fibers have an average fiber diameter of from about 1.0 micron to about 30 microns.

The first nonwoven fabric layer desirably has an overall basis weight (i.e., a basis weight of the one or more nonwoven fabric layers combined) of less than about 50 grams per square meter (gsm). More desirably, the first nonwoven fabric layer has an overall basis weight of from about 25 gsm to about 35 gsm. Even more desirably, the first nonwoven fabric layer has an overall basis weight of about 30 gsm.

The first nonwoven fabric layer may have an overall thickness (i.e., a thickness of the one or more nonwoven fabric layers combined), which varies depending upon the particular end use of the article. Desirably, the first nonwoven fabric layer has an overall thickness of less than about 1000 microns (μm). More desirably, the first nonwoven fabric layer has an overall thickness of from about 10 μm to about 500 μm. Even more desirably, the first nonwoven fabric layer has an overall thickness of from about 20 μm to about 100 μm.

In one exemplary embodiment, the first nonwoven fabric layer comprises a cross-lapped, spunlaced fabric of polyvinyl alcohol fibers, wherein the spunlaced fabric has a basis weight of about 30 gsm.

In some exemplary embodiments, the first layer further comprises a water repellant treatment so as to repel water that may come into contact with an outer surface. For example, in one desired embodiment, the first layer comprises a cross-lapped, spun-laced fabric of polyvinyl alcohol fibers having a water repellant treatment thereon. The water repellant treatment may penetrate the entire thickness of the first layer or may penetrate less than the entire thickness. For example, the water repellant treatment may penetrate from about 10% to 90% of the thickness of the first layer.

Any known water repellant treatment may be used to provide water repellancy to the first layer. Suitable water repellant treatment materials include, but are not limited to, fluorochemicals, waxes, etc., and combinations thereof. Suitable waxes and fluorocarbons include, but are not limited to, paraffin waxes and perfluorinated polyacrylate copolymers.

One possible water repellant treatment composition comprises from about 0.01 to about 1.0 wt % of one or more optional pigments (e.g., phthalocyanine pigment (blue) (Sandoz) or 3,3′-dichlorobenzidine derivatives (yellow) (Sandoz), from about 2 to about 50 wt % of a wax emulsion (e.g., 10 wt % paraffin wax, 10 wt % melamine resin, and 80 wt % water), from about 2 to about 50 wt % of a fluorochemical (e.g., perfluorinated polyacrylate copolymer), and from about 0.01 to about 30 wt % of an optional binder (e.g., used if pigments are employed, such as a polyvinyl alcohol solution), and from about 0.01 to about 30 wt % of a foaming agent (e.g., a surfactant), and the remainder water.

Typically, the water repellency treatment composition comprises up to about 10 wt % of one or more fluorochemicals or waxes, more typically, about 8 wt % of a fluorochemical (e.g., perfluorinated polyacrylate copolymer), and is applied so as to penetrate the entire thickness of the first layer. The water repellency treatment composition may represent greater than 0% up to about 50 wt % of a total weight of the first layer once applied.

Any coating device may be used to apply the water repellency treatment composition. One device suitable for the application of the water repellency treatment composition is described in U.S. Pat. No. 4,655,056, the subject matter of which is hereby incorporated by reference in its entirety.

2. Polymeric Film Layer

The biodegradable and/or water-soluble articles of the present invention further comprise a polymeric film layer that is preferably liquid impervious such as exemplary polymeric film layer 14 of exemplary biodegradable and/or water-soluble article 10 shown in FIG. 1. The polymeric film layer of the biodegradable article may comprise one or more layers of polymeric material positioned adjacent to and/or bonded to one another.

Each of the polymeric film layers may comprise any biodegradable and/or water-soluble polymeric film-forming material. In some embodiments, the polymeric film layer (e.g., exemplary polymeric film layer 14) comprises one or more biodegradable polymeric film-forming materials. Suitable biodegradable film-forming materials include, but are not limited to, polylactic acid. In these embodiments, the polymeric film-forming material is desirably liquid impervious but breathable, so that gases may pass through the layer but liquids do not. Commercially available polylactic acid film material suitable for use in the present invention includes, but is not limited to, polylactic acid film material commercially available from NatureWorks, LLC (Minneapolis, Minn.), a division of Cargill, Incorporated (Minneapolis, Minn.) under the trade designation PLA Polymer 2002D.

In other embodiments, the polymeric film layer (e.g., exemplary polymeric film layer 14) comprises one or more water-soluble polymeric film-forming materials. Suitable water-soluble film-forming materials include, but are not limited to, polyvinyl alcohol. In these embodiments, the polymeric film-forming material may either be (i) liquid and vapor impervious (i.e., not breathable) or (ii) liquid impervious, but pervious to vapor (e.g., water vapor) (i.e., breathable) so that gases and vapor may pass through the layer but liquids do not. Commercially available polyvinyl alcohol film material suitable for use in the present invention includes, but is not limited to, polyvinyl alcohol film material commercially available from Kuraray Co., Ltd. (Japan).

In embodiments in which the polymeric film layer (e.g., exemplary polymeric film layer 14) comprises one or more water-soluble polymeric film-forming materials, the polymeric film layer (and the entire article, such as exemplary biodegradable and/or water-soluble article 10) is desirably water-soluble in water having a water temperature of greater than about 37° C. (or greater than about 50° C., or greater than about 75° C., or greater than about 90° C.).

The polymeric film layer may have an overall thickness (i.e., a thickness of the one or more polymeric film layers combined), which varies depending upon the particular end use of the article. Desirably, the polymeric film layer has an overall thickness of less than about 100 microns (μm). More desirably, the polymeric film layer has an overall thickness of from about 10 μm to about 64 μm (2.5 mil). Even more desirably, the polymeric film layer has an overall thickness of from about 38 μm (1.5 mil) to about 64 μm (2.5 mil). In one exemplary embodiment, the polymeric film layer comprises a polylactic acid film or polyvinyl alcohol film having an overall thickness of about 38 μm (1.5 mil).

The polymeric film layer desirably has an overall basis weight (i.e., a basis weight of the one or more polymeric film layers combined) of less than about 45 grams per square meter (gsm). More desirably, the polymeric film layer has an overall basis weight of from about 5 gsm to about 45 gsm. Even more desirably, the polymeric film layer has an overall basis weight of about 20 gsm to about 35 gsm.

In some embodiments of the present invention, at least a portion of the polymeric film layer is bonded to at least a portion of the above-described first layer of nonwoven fabric and an opposite surface of the polymeric film layer is bonded to at least a portion of a second layer of nonwoven fabric. In one exemplary embodiment, such as exemplary biodegradable and/or water-soluble article 10 shown in FIGS. 1-2, the polymeric film layer is bonded to first and second nonwoven layers in a uniform manner (e.g., point-bonded) along outer film surfaces. In other embodiments, polymeric film layer is bonded to first and second nonwoven layers in desired areas, which may or may not be uniformly distributed along an outer film surface.

In some embodiments of the present invention, it is desirable to have filler particles 60 (as shown in FIG. 1) distributed throughout the polymeric film layer such that the polymeric film layer comprises voids 62 formed around the filler particles 60 so as to facilitate passage of water vapor through the polymeric film layer. When present, such filler particles may comprise a variety of inorganic particles, such as silica, clay, calcium carbonate, talc, and combinations thereof, typically having an average particle diameter of less than 25 microns, and be present in an amount of up to about 50 wt % based on a total weight of the film. Such voids improve the breathability of the biodegradable and/or water-soluble article without negatively impacting the liquid impermeability of the biodegradable and/or water-soluble article.

The breathable unstretched polymer films used to form articles in the present invention typically have a water vapor transmission rate (WVTR) of at least 2000 g/24 hr/m² as measured using test method ASTM 1249F, and more desirably have a WVTR ranging from about 3000 to about 5000 g/24 hr/m² as measured using test method ASTM 1249F. In one desired embodiment, a breathable unstretched polyvinyl alcohol film of the present invention has a WVTR ranging from about 4000 to about 4300 g/24 hr/m² as measured using test method ASTM 1249F.

Typically, the polymeric film layer comprises a polymer matrix with one or more optional additives (e.g., filler materials, pigments, antimicrobial agents, etc.) distributed throughout the polymer matrix. In one exemplary embodiment, the polymeric film layer comprises a polymer matrix comprising from about 55 wt % to 100 wt % of a biodegradable polymer (e.g., polylactic acid) or a water-soluble polymer (e.g., polyvinyl alcohol), and from about 45 wt % to 0 wt % of one or more additives (e.g., filler material such as calcium carbonate or silica). In other exemplary embodiments, the polymeric film layer comprises a polymer matrix comprising from about 60 wt % (or about 65 wt %, or about 70 wt %, or about 75 wt %, or about 80 wt %, or about 85 wt %, or about 90 wt %, or about 95 wt %) to 100 wt % of a biodegradable polymer (e.g., polylactic acid) or a water-soluble polymer (e.g., polyvinyl alcohol), and from about 40 wt % (or about 35 wt %, or about 30 wt %, or about 25 wt %, or about 20 wt %, or about 15 wt %, or about 10 wt %, or about 5 wt %) to 0 wt % of one or more additives (e.g., filler material such as calcium carbonate or silica).

In one desired embodiment, the polymeric film layer comprises a breathable unstretched polyvinyl alcohol film comprising a polyvinyl alcohol matrix with calcium carbonate nanoparticles substantially uniformly distributed throughout the polyvinyl alcohol matrix. In this exemplary embodiment, the polymeric film layer comprises from about 55 wt % to about 70 wt % of polyvinyl alcohol, and from about 45 wt % to about 30 wt % of calcium carbonate nanoparticles. Desirably, the calcium carbonate nanoparticles have an average particle size of less than about 0.1 nanometers (nm), and more desirably, an average particle size of about 0.05 nm. Such breathable unstretched polyvinyl alcohol films typically have a water vapor transmission rate (WVTR) of from about 4000 to about 4300 g/24 hr/m² as measured using test method ASTM 1249F.

In another desired embodiment, the polymeric film layer comprises a liquid and gas impermeable, optically clear polyvinyl alcohol film comprising a polyvinyl alcohol matrix. Such an optically clear polyvinyl alcohol film is commercially available from Kuraray Co., Ltd. (Japan).

3. Second Layer of Nonwoven Fabric

The biodegradable and/or water-soluble articles of the present invention comprise a second layer of nonwoven fabric such as exemplary second layer of nonwoven fabric 16 of exemplary biodegradable and/or water-soluble article 10 shown in FIG. 1. The second layer of nonwoven fabric is preferably a liquid pervious layer so as to enable fluids coming into contact with a lower/outer surface of the article to enter into the article and away from the lower/outer surface of the article (e.g., the second layer of nonwoven fabric has liquid wicking properties).

The second nonwoven fabric layer of the biodegradable and/or water-soluble article may be similar to or different from the above-described first nonwoven fabric layer. In one exemplary embodiment, second nonwoven fabric layer is essentially identical to first nonwoven fabric layer. In other embodiments, first and second nonwoven fabric layers differ from one another so as to impart a combination of properties to the resulting biodegradable and/or water-soluble article. For example, in one desired embodiment, the first layer is treated with a water repellant treatment as discussed above, while the second layer is untreated. The resulting article has a first nonwoven outer layer that is water repellent and a second nonwoven outer layer that is water absorbent.

Like the first nonwoven fabric layer, the second nonwoven fabric layer may comprise one or more layers of nonwoven fabric material positioned adjacent to and/or bonded to one another. In one exemplary embodiment, the second nonwoven fabric layer comprises a cross-lapped, spun-laced fabric.

Each of the second nonwoven fabric layers may be formed from a variety of materials. Suitable materials include, but are not limited to, materials listed above suitable for forming the first nonwoven fabric layer. In one desired embodiment, each of the second nonwoven fabric layers comprises polyvinyl alcohol fibers as described above. When formed from water-soluble fibers, second layer of nonwoven fabric 16 is desirably water-soluble in water having a water temperature of greater than about 37° C. (or greater than about 50° C., or greater than about 75° C., or greater than about 90° C.).

The second nonwoven fabric layer desirably has an overall basis weight (i.e., a basis weight of the one or more nonwoven fabric layers combined) of less than about 50 grams per square meter (gsm). More desirably, the second nonwoven fabric layer has an overall basis weight of from about 25 gsm to about 35 gsm. Even more desirably, the second nonwoven fabric layer has an overall basis weight of about 30 gsm.

The second nonwoven fabric layer may have an overall thickness (i.e., a thickness of the one or more nonwoven fabric layers combined), which varies depending upon the particular end use of the article. Desirably, the second nonwoven fabric layer has an overall thickness of less than about 1000 microns (μm). More desirably, the second nonwoven fabric layer has an overall thickness of from about 10 μm to about 500 μm. Even more desirably, the second nonwoven fabric layer has an overall thickness of from about 20 μm to about 100 μm.

In one exemplary embodiment, the second nonwoven fabric layer comprises a cross-lapped, spunlaced fabric of polyvinyl alcohol fibers, wherein the spunlaced fabric has a basis weight of about 30 gsm.

4. Additives

Any of the above-described biodegradable and/or water-soluble article components may further comprise one or more additives coated onto or incorporated into one or more of the materials used to form an individual component. Suitable additives include, but are not limited to, antimicrobial agents, colorants (e.g., pigments), softeners, additives to increase or decrease the coefficient of friction of a given component layer, additives to increase the hydrophilicity of a given component layer, flame retardants, fillers, etc. In one desired embodiment of the present invention, one or more components of the biodegradable and/or water-soluble article comprise an antimicrobial agent incorporated therein. Suitable antimicrobial agents include, but are not limited to, triclosan and other antimicrobial agents commercially available under the trade designation MICROBAN® from Microban International, Ltd. (New York, N.Y.).

In one exemplary embodiment, first layer of nonwoven fabric 12, polymeric film layer 14, and/or second layer of nonwoven fabric 16 may each contain one or more of the above-mentioned additives, such as antimicrobial agents commercially available under the trade designation MICROBAN®.

The various additives may be added to a polymer melt and extruded to incorporate the additive into a fiber or film component. Alternatively, one or more additives may be coated onto a fiber or film during or after the fabric or film forming process. Typically, when present, each of the one or more additives is present in an amount less than about 10 weight percent, desirably, up to about 2.5 weight percent, based on the total weight of the fiber, film or fabric.

B. Other Article Features

In addition to the above-described components, the biodegradable and/or water-soluble articles of the present invention may comprise one or more of the following features.

1. Dimensions

Articles according to the present invention may take any appropriate form including, but not limited to, articles of clothing (e.g., coveralls, scrubs, shoe covering, booties, shirts, pants, face masks, etc.), gowns, patient drapes, and operating room equipment drapes. Operating room equipment drapes of the present invention have dimensions sufficient to cover at least a portion of a piece of equipment, and in some embodiments, the entire piece of equipment. Exemplary pieces of equipment include, but are not limited to, an operating room table, an operating room table mattress, a cart, etc. Typically, the operating room equipment drape has dimensions so that the operating room equipment drape completely covers an upper surface of an object, such as an operating room table or mattress; however, it should be understood that there is no limitation whatsoever regarding the dimensions of the operating room equipment drapes or the biodegradable and/or water-soluble articles of the present invention.

In one exemplary embodiment of the present invention, the operating room equipment drape has a width ranging from about 24 to about 60 inches, and a length ranging from about 48 to about 104 inches. For example, the operating room equipment drape may have a width of about 40 inches, and a length of about 96 inches.

2. Elastic Hemline

In a further embodiment of the present invention, and whether shaped as an article of clothing, a gown, or an operating room equipment drape, the article may comprise one or more elastic hemlines along at least a portion of the outer periphery. For example, as shown in FIG. 2, exemplary article 10 can have an elastic hemline extending along one or more edges 46 and 48. In other embodiments, the elastic hemline may extend around the entire outer periphery of the article. The presence of an elastic hemline enables the biodegradable and/or water-soluble article of the present invention to better fit onto an operating table or table mattress similar to the way an elastic hemline in a bedsheet enables the bedsheet to better fit onto a bed mattress. Similar benefits are obtained if the article is shaped as a gown or article of clothing.

II. Methods of Making Biodegradable and/or Water-Soluble Articles and Components

The present invention is further directed to methods of making biodegradable and/or water-soluble articles and components for the articles. Any of the above-described individual components used to form the various biodegradable and/or water-soluble articles of the present invention may be formed using conventional methods. For example, polymeric film layers may be forming via any film-forming process including, but not limited to, a film extrusion process, a film-forming process from solution, a film-blowing process, etc. Fiber-containing layers, such as a nonwoven fabric layer, may be formed using conventional processes including, but not limited to, meltblowing processes, spunbonding processes, spunlacing processes, hydroentangling processes, carding processes, needlepunching processes, etc.

When the polymeric film layer(s) contains additives, the one or more additives may be added to a polymer melt and subsequently formed (e.g., extruded, solution coated, etc.) into a filled polymer film. In embodiments in which the breathability is enhanced due to the presence of voids in the filled polymer film (e.g., exemplary polymeric film layer 14 of exemplary biodegradable and/or water-soluble article 10 shown in FIG. 1), the filled polymer film may be optionally stretched in one or more directions in order to create voids between the filler particles (e.g., filler particles 60 shown in FIG. 1) and the polymer matrix of the polymer film.

Films and fabric layers may be joined to one another using any conventional bonding technique including, but not limited to, thermal bonding processes, adhesive bonding, mechanical bonding, etc. In one exemplary embodiment of the present invention, a polymeric film layer may be bonded to a nonwoven fabric layer using a conventional point-bonding apparatus, wherein thermal bonds are used to join the polymeric film layer to one or both of the nonwoven fabric layers. In another exemplary embodiment of the present invention, a polymeric film layer may be bonded to outer nonwoven fabric layers using a high frequency (e.g., ultrasonic) point-bonding apparatus, wherein bonds are used to join the polymeric film layer to both of the nonwoven fabric layers. The degree of bonding, size of individual point bonds, and concentration of point bonds may vary as desired.

The present invention is further directed to methods of making a breathable unstretched water-soluble polyvinyl alcohol film. In one exemplary embodiment, the method of making a breathable unstretched water-soluble polyvinyl alcohol film comprises forming an aqueous mixture of (i) water-soluble polyvinyl alcohol, and (ii) inorganic nanoparticles (e.g., calcium carbonate nanoparticles); depositing the mixture onto a moving surface traveling through an oven; subjecting the deposited mixture to heat so as to remove water; and separating the resulting film from the moving surface without stretching the film. Typically, an aqueous solution comprising from about 10 to about 30 wt % (more typically, from about 10 to about 20 wt %) polyvinyl alcohol pellets and from about 90 to about 70 wt % (more typically, from about 10 to about 80 wt %) water is first prepared. Then, from about 2 to about 15 wt % of inorganic nanoparticles (e.g., calcium carbonate nanoparticles), based on a weight of the aqueous solution (e.g., the polyvinyl alcohol/water mixture), is added to the aqueous mixture and blended for up to about 2.0 hours at a blend temperature ranging from about 60 to about 98° C.

The blended mixture is then deposited on a moving flat surface and moved through a circulating oven having an oven temperature ranging from about 60 to about 100° C. A given square meter of aqueous solution is typically subjected to an oven dwell time ranging from about 5 to about 15 minutes depending on oven temperature, air flow, etc. so as to remove water from the aqueous solution and produce a polyvinyl alcohol film filled with inorganic powder. The resulting polyvinyl alcohol film exited the oven is separated from the moving surface and taken-up in roll form with minimal tension on the film (i.e., no stretching).

The present invention is even further directed to methods of making an article using a high frequency bonding or welding technique. In one exemplary embodiment, the method of making an article comprises feeding (i) a first layer of nonwoven fabric comprising hot water-soluble polyvinyl alcohol fibers, (ii) a second layer of nonwoven fabric comprising hot water-soluble polyvinyl alcohol fibers, and (iii) a biodegradable or water-soluble polymeric film layer positioned between the first and second layers of nonwoven fabric into a high frequency welding apparatus, wherein the high frequency welding apparatus comprises a pair of nip rollers comprising (i) a first roller having a plurality of protrusions along an outer surface of the first roller, and (ii) a second roller having a substantially smooth surface, the high frequency welding apparatus providing high frequency energy across a nip area between the protrusions of the first roller and the substantially smooth surface of the second roller; and bonding the first layer of nonwoven fabric, the second layer of nonwoven fabric, and the polymeric film layer to one another via the high frequency energy.

In the high frequency bonding or welding technique or ultrasonic lamination technique, a frequnecy ranging from about 80 to about 130 HZ is used depending on the bond strength desired, the materials bonded, the line speed, etc. Typical line speeds may range from about 20 to about 30 meters per minute (mpm).

A variety of high frequency bonding or welding apparatus may be used in the present invention. Suitable types of high frequency bonding or welding equipment are available from companies such as Chase Machine & Engineering, Inc. (West Warwick, R.I.).

Other bonding methods may be used although high frequency bonding or welding is a desired bonding method. Other suitable bonding methods include, but are not limited to, heat/thermal bonding with or without pressure, and adhesive bonding using a glue-like material.

In one desired embodiment, a biodegradable polymeric film layer comprising polylactic acid and optional filler material (e.g., silica or calcium carbonate) is extruded and subsequently bonded to opposing nonwoven fabric layers comprising water-soluble polyvinyl alcohol fibers using a conventional thermal point-bonding apparatus. In this embodiment, the biodegradable polymeric film layer consists of a polylactic acid matrix and optional filler material dispersed therein.

In another desired embodiment, a water-soluble polymeric film layer comprising polyvinyl alcohol and optional filler material (e.g., silica or calcium carbonate) is formed from solution and subsequently bonded to opposing nonwoven fabric layers comprising water-soluble polyvinyl alcohol fibers using a high frequency (e.g., ultrasonic welding) point-bonding apparatus. In this embodiment, the water-soluble polymeric film layer consists of a polyvinyl alcohol matrix and optional filler material dispersed therein.

III. Methods of Using Biodegradable and/or Water-Soluble Articles

The present invention is further directed to methods of using the above-described biodegradable and/or water-soluble articles. In one exemplary embodiment, the method comprises a method of providing a barrier between a patient and a piece of equipment in an operating room setting, wherein the method comprises the step of positioning the equipment drape over at least a portion of the piece of equipment to separate the patient from at least a portion of the piece of equipment. Typically, the equipment drape is used to cover the entire piece of equipment. In one desired embodiment, the piece of equipment comprises an operating room table and/or operating room table mattress.

In another exemplary embodiment, the method comprises a method of covering a patient during a surgical procedure so as to provide a barrier between the patient and, for example, a surgeon and/or to expose a surgical site on a patient while covering at least a portion of the remaining body of a patient (e.g., through a fenestration in the patient drape).

Following use, the biodegradable and/or water-soluble articles of the present invention may be disposed of by one of two methods. When the biodegradable and/or water-soluble article of the present invention comprises a biodegrable, but not water-soluble, polymeric film, the method comprises solubilizing the nonwoven fabric layers of the biodegradable and/or water-soluble article by exposing the nonwoven fabric layers to a water temperature in which the nonwoven fabric layers become soluble (e.g., greater than about 37° C., or greater than about 50° C., or greater than about 75° C., or greater than about 90° C.), and then disposing of the biodegradable film via conventional waste management systems (e.g., burying in a landfill). When the biodegradable and/or water-soluble article of the present invention comprises a water-soluble polymeric film, the method comprises solubilizing the nonwoven fabric layers and the water-soluble polymeric film of the water-soluble article by exposing the nonwoven fabric layers and the water-soluble polymeric film to a water temperature in which the nonwoven fabric layers and the water-soluble polymeric film become soluble (e.g., greater than about 37° C., or greater than about 50° C., or greater than about 75° C., or greater than about 90° C.).

In some embodiments, the method of disposal may include additional steps including, but not limited to, shredding the biodegradable film into smaller pieces, collecting the biodegradable film for disposal separate from other waste, etc.).

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Preparation of a Breathable Polyvinyl Alcohol Film

An aqueous solution comprising about 15 wt % polyvinyl alcohol (PVOH pellets commercially available from Fujian Textile and Fiber Group (Fujian, China) under the Product Code 2499) and 85 wt % water was prepared. Calcium carbonate powder having an average particle size of about 0.05 nanometers (nm) (commercially available from Reade Advanced Materials (East Providence, R.I.)) was added to the aqueous solution. The aqueous solution was blended for about 1.5 hours at a blend temperature of about 85 to 95° C. The blended mixture was then deposited on a moving flat surface having a surface width of about 1 meter (m) so as to form a coating having an average coating thickness of about 76 μm (3 mil). The moving flat surface covered with aqueous solution was moved through a circulating oven having an oven temperature of about 98° C. A given square meter of aqueous solution was subjected to the oven temperature of about 98° C. for about 12 minutes so as to remove water from the aqueous solution and result in a polyvinyl alcohol film filled with calcium carbonate powder. The resulting polyvinyl alcohol film exited the oven and was separated from the moving surface and taken-up in roll form with minimal tension on the film (i.e., no stretching).

The resulting unstretched polyvinyl alcohol film comprised about 60 wt % polyvinyl alcohol and about 40 wt % calcium carbonate powder and had a film thickness of about 38 microns (μm) (about 1.5 mils). The resulting unstretched polyvinyl alcohol film had a water vapor transmission rate (WVTR) of about 4200 g/24 hr/M² as measured using test method ASTM 1249F.

### EXAMPLE 2

### Preparation of a Breathable Polylactic Acid Film

A melt blend of about 60 wt % polylactic acid (PLA pellets commercially available from Dow Cargill (Minneapolis, Minn.)) and 40 wt % calcium carbonate powder having an average particle size of about 0.05 nanometers (nm) (commercially available from Reade Advanced Materials (East Providence, R.I.)) was formed. The melt blend was extruded at an extrusion temperature of about 151° C.

The resulting unstretched polylactic acid film comprised about 60 wt % polylactic acid and about 40 wt % calcium carbonate powder and had a film thickness of about 38 microns (μm) (about 1.5 mils). The polylactic acid film had a water vapor transmission rate (WVTR) of about 4000 g/24 hr/m² as measured using test method ASTM 1249F.

### EXAMPLE 3

### Preparation of a Breathable Tri-Laminate Composite Material

The unstretched polyvinyl alcohol film formed in Example 1 was fed into a high frequency bonding apparatus along with outer nonwoven webs of cross-lapped spun-laced polyvinyl alcohol fibers. Each of the outer layers had a basis weight of about 30 grams per square meter (gsm). The high frequency bonding apparatus comprised (i) a first roller having a width of about 1.6 meters and thousands of cylindrical shaped protrusions along an outer surface of the first roller, and (ii) a second roller having a width of about 1.6 meters and a substantially smooth surface. Each of the cylindrical shaped protrusions provided high frequency energy at a frequency of about 120 Hz at points of contact between the first roller and the second roller so as to supply high frequency energy to the material passing between the rollers. Both rollers had a roll diameter of about 45.7 centimeters (cm) (18 inches).

The unstretched polyvinyl alcohol film and outer nonwoven webs of cross-lapped spun-laced polyvinyl alcohol fibers were fed through the high frequency bonding apparatus at a line speed of about 25 meters per minute (mpm). Each protrusion provided a high frequency bonding area having an average bond area of about 0.64 mm² with about 16 bond areas per cm².

The resulting tri-laminate composite material had a water vapor transmission rate (WVTR) of about 4200 g/24 hr/m² as measured using test method ASTM 1249F, and was hot water soluble.

### EXAMPLE 4

### Preparation of a Breathable Composite Tri-Laminate Material

The procedure of Example 3 was repeated except the unstretched polylactic acid film formed in Example 2 was fed into the high frequency bonding apparatus along with outer nonwoven webs of cross-lapped spun-laced polyvinyl alcohol fibers.

The resulting tri-laminate composite material had a water vapor transmission rate (WVTR) of about 4000 g/24 hr/m² as measured using test method ASTM 1249F, and was biodegradable and hot water soluble.

### EXAMPLE 5

### Preparation of a Composite Tri-Laminate Material

The procedure of Example 3 was repeated except a commercially available optically clear polyvinyl alcohol film (PVOH film commercially available from Kuraray Co., Ltd. (Japan)) was used in place of the unstretched polyvinyl alcohol film formed in Example 1.

The resulting tri-laminate composite material was not breathable, but was 100% hot water soluble. Outer edges of the resulting tri-laminate composite material that comprised only the polyvinyl alcohol film were optically clear.

### EXAMPLE 6

### Preparation of Water-Resistant Tri-Laminate Composite Materials

Tri-laminate composite materials were formed using the procedures as described in Examples 3 and 5 except one outer layer of cross-lapped spun-laced polyvinyl alcohol fibers was first chemically treated to provide water-resistance to the web prior to the high frequency bonding step. The treated outer layer of cross-lapped spun-laced polyvinyl alcohol fibers was dipped in an aqueous solution comprising 8 wt % of a perfluorinated polyacrylate copolymer (commercially available from 3M Company (St. Paul, Minn.), and 92 wt % water at a line speed of 18 meters/minute (mpm), and dried.

The resulting tri-laminate composite materials has properties similar to those described in Examples 3 and 5 except one outer layer of the resulting tri-laminate composite materials was water repellant, while the opposite layer of cross-lapped spun-laced polyvinyl alcohol fibers remained water absorbent.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. An article comprising:
a first layer of nonwoven fabric extending along a first surface of the article, said first layer of nonwoven fabric comprising water-soluble fibers;
a second layer of nonwoven fabric extending along a second surface of the article, said second layer of nonwoven fabric comprising water-soluble fibers; and
a polymeric film layer positioned between and bonded to said first and second layers of nonwoven fabric, said polymeric film layer comprising (i) a biodegradable polymer that is not water-soluble or (ii) a water-soluble polymer.

2. The article of claim 1, wherein the water-soluble fibers comprise polyvinyl alcohol fibers.

3. The article of claim 1, wherein the first and second layers comprise cross-lapped, spunlaced nonwoven fabric layers.

4. The article of claim 1, wherein the first layer further comprises a water repellant treatment, said first layer being water repellent and said second layer being water absorbent.

5. The article of claim 1, wherein said polymeric film layer comprises a biodegradable polymer, and the biodegradable polymer comprises polylactic acid.

6. The article of claim 1, wherein at least one of the first and second layers comprises polyvinyl alcohol fibers, said polymeric film layer comprises a biodegradable polymer, and the biodegradable polymer comprises polylactic acid.

7. The article of claim 1, wherein the first and second layers comprise polyvinyl alcohol fibers, said polymeric film layer comprises a biodegradable polymer, and the biodegradable polymer comprises polylactic acid.

8. The article of claim 1, wherein said polymeric film layer comprises a water-soluble polymer, and the water-soluble polymer comprises polyvinyl alcohol.

9. The article of claim 1, wherein at least one of the first and second layers comprises polyvinyl alcohol fibers, said polymeric film layer comprises a water-soluble polymer, and the water-soluble polymer comprises polyvinyl alcohol.

10. The article of claim 1, wherein the first and second layers comprise polyvinyl alcohol fibers, said polymeric film layer comprises a water-soluble polymer, and the water-soluble polymer comprises polyvinyl alcohol.

11. The article of claim 1, wherein the polymeric film layer further comprises filler particles and voids formed around the filler particles so as to facilitate passage of water vapor through the polymeric film layer.

12. The article of claim 11, wherein the filler particles comprise silica, calcium carbonate, or a mixture thereof.

13. The article of claim 10, wherein said polymeric film layer comprises an optically clear polyvinyl alcohol film consisting essentially of polyvinyl alcohol.

14. The article of claim 10, wherein said polymeric film layer comprises a breathable polyvinyl alcohol film.

15. The article of claim 14, wherein said breathable polyvinyl alcohol film has a water vapor transmission rate (WVTR) of at least about 4000 g/24 hr/m² as measured using test method ASTM 1249F.

16. The article of claim 14, wherein said breathable polyvinyl alcohol film comprises an unstretched polyvinyl alcohol film having a polyvinyl alcohol matrix and calcium carbonate nanoparticles dispersed therein.

17. The article of claim 16, wherein said breathable polyvinyl alcohol film comprises from about 55 to about 70 wt % polyvinyl alcohol and from about 45 to about 30 wt % calcium carbonate nanoparticles.

18. The article of claim 1, wherein at least one of the first and second layers is soluble in water having a water temperature of greater than 50° C.

19. The article of claim 1, wherein at least one of the first and second layers is soluble in water having a water temperature of greater than 75° C.

20. The article of claim 1, wherein at least one of the first and second layers is soluble in water having a water temperature of greater than 90° C.

21. The article of claim 1, wherein the first and second layers and the polymeric film layer are soluble in water having a water temperature of greater than 50° C.

22. The article of claim 1, wherein the first and second layers and the polymeric film layer are soluble in water having a water temperature of greater than 75° C.

23. The article of claim 1, wherein the first and second layers and the polymeric film layer are soluble in water having a water temperature of greater than 90° C.

24. The article of claim 1, further comprising an antimicrobial agent in at least one layer.

25. The article of claim 1, further comprising a flame retardant agent in at least one layer.

26. The article of claim 1, wherein the first and second layers and the polymeric film layer are bonded to one another using a high frequency welding technique without additional bonding agents.

27. An operating room drape comprising the article of claim 13.

28. An article of clothing comprising the article of claim 14.

29. The article of clothing of claim 28, wherein said article of clothing comprises an operating room gown.

30. The article of clothing of claim 29, wherein the first layer further comprises a water repellant treatment, said first layer being water repellent and said second layer being water absorbent.

31. An operating room drape comprising:
a first layer of nonwoven fabric extending along a first surface of the article, said first layer of nonwoven fabric comprising water-soluble polyvinyl alcohol fibers;
a second layer of nonwoven fabric extending along a second surface of the article, said second layer of nonwoven fabric comprising water-soluble polyvinyl alcohol fibers; and
a liquid impervious polymeric film layer positioned between and bonded to said first and second layers of nonwoven fabric without an additional bonding agent, said polymeric film layer comprising (i) a biodegradable polymer that is not water-soluble or (ii) a water-soluble polymer.

32. The operating room drape of claim 31, wherein the first and second layers comprise cross-lapped, spun-laced nonwoven fabric layers consisting essentially of polyvinyl alcohol fibers, and said polymeric film layer comprises an optically clear polyvinyl alcohol film consisting essentially of polyvinyl alcohol.

33. The operating room drape of claim 32, wherein each of said cross-lapped, spun-laced nonwoven fabric layers have a basis weight of from about 30 to about 35 gsm, and said optically clear polyvinyl alcohol film has a film thickness of from about 38 to about 64 μm.

34. An article of clothing comprising:
a first layer of nonwoven fabric extending along a first surface of the article, said first layer of nonwoven fabric comprising water-soluble polyvinyl alcohol fibers;
a second layer of nonwoven fabric extending along a second surface of the article, said second layer of nonwoven fabric comprising water-soluble polyvinyl alcohol fibers; and
a breathable unstretched polymeric film layer positioned between and bonded to said first and second layers of nonwoven fabric, said breathable unstretched polymeric film layer comprising:
a polymer matrix comprising (i) a biodegradable polymer that is not water-soluble or (ii) a water-soluble polymer; and
filler particles distributed throughout the polymer matrix.

35. The article of clothing of claim 34, wherein the first and second layers comprise cross-lapped, spun-laced nonwoven fabric layers consisting essentially of polyvinyl alcohol fibers, and said breathable unstretched polymeric film layer comprises a polyvinyl alcohol matrix and calcium carbonate nanoparticles dispersed therein.

36. The article of clothing of claim 35, wherein said breathable polyvinyl alcohol film comprises from about 55 to about 70 wt % polyvinyl alcohol and from about 45 to about 30 wt % calcium carbonate nanoparticles.

37. The article of clothing of claim 36, wherein each of said cross-lapped, spun-laced nonwoven fabric layers have a basis weight of from about 30 to about 35 gsm, and said breathable unstretched polymeric film layer has a film thickness of from about 38 to about 64 μm (1.5 to about 2.5 mil.).

38. The article of clothing of claim 35, wherein the first layer further comprises a water repellant treatment on the cross-lapped, spun-laced nonwoven fabric layer, said first layer being water repellent and said second layer being water absorbent.

39. The article of clothing of claim 38, wherein said article of clothing comprises an operating room gown.

40. The article of clothing of claim 38, wherein said article of clothing comprises a coverall.

41. The article of clothing of claim 38, wherein said article of clothing comprises scrubs.

42. A method of providing a barrier between a patient and a piece of equipment in an operating room setting, said method comprising the steps of:
positioning an equipment drape over at least a portion of the piece of equipment to separate the patient from the portion of the piece of equipment, wherein the equipment drape comprises the operating room drape of claim 33.

43. A method of making the article of claim 1, said method comprising:
feeding the first layer of nonwoven fabric, the second layer of nonwoven fabric, and the polymeric film layer positioned between the first and second layers of nonwoven fabric into a high frequency welding apparatus, the high frequency welding apparatus comprising a pair of nip rollers comprising (i) a first roller having a plurality of protrusions along an outer surface of the first roller, and (ii) a second roller having a substantially smooth surface, the high frequency welding apparatus providing high frequency energy across a nip area between the protrusions of the first roller and the substantially smooth surface of the second roller; and
bonding the first layer of nonwoven fabric, the second layer of nonwoven fabric, and the polymeric film layer to one another via the high frequency energy.
